(19) United States
(12) Patent Application Publication
(10) Pub. No.: US 2001/0033768 A1
(43) Pub. Date: Oct. 25, 2001

(54) Binder insert

(76) Inventor: Chikara Mochizuki, Osaka (JP)

Correspondence Address: Thompson Hine & Flory LLP, 2000 Courthouse Plaza N.E., P.O. Box 8801, Dayton, OH, 45401-8801, US

(21) Appl. No.: 09/804,166

(22) Filed: Mar. 12, 2001

(30) Foreign Application Priority Data
Mar. 13, 2000 (JP) 2000-68774

(51) Int. Cl. B42F 13/00

(52) U.S. Cl. 402/79

(57) ABSTRACT

An object of the present invention is to provide a binder insert for a pocket-type album easy to take a panorama and a high-vision-sized photographs in and out without losing a fine appearance. A conventional binder insert having a slit provided at an upper portion of a film cover have a difficulty in particularly taking a panorama and a high-vision-sized photograph in and out. The present invention in a three-pocket-type album same in a basic structure with the conventional pocket-type album adopts a method of providing a slit at an inferior portion of a film cover to take a panorama or a high-vision-sized photograph in and out.

### FIELD OF THE INVENTION

The present invention relates to an improvement in a pocket-type album capable of storing a plurality of standard-sized photographs as well as panorama and high-vision sized photographs which are longer in width than the standard-sized photographs.

### DESCRIPTION OF THE PRIOR ART

FIG. 4 shows a basic structure of a binder insert used for a conventional pocket-type album. In this figure, 20 is a mount as a base and 21 is a transparent film cover sheathing the base 20 with forming three pockets 22 lengthways. The film cover 21 is bag-shaped, wherein only a side of a memo margin 23 provided in the mount 20 is opened and other three sides are closed. The pocket 22 is to be formed by adhering the film cover 21 to the mount 20 when pairs of holes 24 and 25 are created to form three equal pockets in the film cover 21. Each of the pockets 22 is designed to store a standard-service-sized photograph. Accordingly, three of popular sized photographs in one side and six in both sides can be stored with this structure. A conventional pocket-type album has a slit 26 provided at an upper portion of the film cover 21. The slit 26 is an insertion slit to vertically place a panorama and/or a high-vision sized photograph which is longer than a service-sized photograph in width. An interval of pairs of holes 24 and 25 is set to be shorter than a longer side of a service-sized photograph and longer than a shorter side of a panorama and a high-vision sized photograph. With the above structure, at least the above three sizes photograph can be stored selectively.

Under APS(advanced print system), three kinds of print sizes except for a most popular size in Japan as it is “service-size” (127 mm×89 mm) are provided. One of them is a panorama size which is set to a size of 89×254 (mm) in Japan and 4×10 (inch) in U.S. including Kodak type (hereafter Kodak type is included in U.S.). A high-vision size is set to a size of 89×158 (mm) in Japan and 4×7 (inch). The remaining one is a postcard size which is set to a size of 102×148 (mm) in Japan and 4×6 (inch) in U.S.

### SUMMARY OF THE INVENTION

As described above, there already exists a pocket-type album having a film cover provided with a slit to insert a panorama and/or a high-vision-sized photograph as well as a service-sized photograph and holes punched in a mount with suitable intervals. As examples, Publication No. H6-45765 of unexamined Japanese Utility Model Application and Japanese Utility Model No. 3001714 can be referred.

The problem of a conventional pocket-type album is a slit provided at an upper portion of a film cover. When a position of a slit is set at an upper portion of a film cover, a finger cannot reach to a superior border of a photograph or may tear a slit as trying to pull out the photograph inserted inside deeply. According to measurement by an inventor of the present invention, a superior border of a panorama-sized photograph is at a distance of approximately 46 mm to 64 mm from a slit of a conventional position. In the case of a high-vision-sized photograph, a distance is approximately 122 mm to 159 mm from a slit of a conventional position. When a panorama and/or a high-vision-sized photograph is to be placed, it is preferable that an inferior border thereof reaches to a bottom of a film cover in order to have stability in appearance and avoid a tilt thereof. Also, a slit with a small opening is preferable for a better appearance, which indicates that providing a plurality of slits in accordance with a panorama and/or a high-vision sized photograph or changing a form of a slit to facilitate taking photographs in and out is not the best way.

An object of the present invention is to provide a binder insert for a pocket-type album easy to take a panorama and/or a high-vision-sized photograph in and out without losing a fine appearance. To achieve the above object, a binder insert for a three-pocket-type album, which is the same in a basic structure as the conventional pocket-type album, adopts a method of providing a slit at an inferior portion of a film cover to take a panorama and/or a high-vision-sized photograph in and out. The slit is for taking in and out a photograph which is longer in width than a service-size photograph and placed upright. As an inferior border of a photograph is positioned in the very vicinity of the slit, a wide photograph can be easily pulled out without inserting a finger deeply inside the film cover.

A pocket of the present invention described in claim 2 is designed to store a postcard-sized photograph, whereby the present invention in claim 2 is capable to store maximally four kinds of photograph sizes which are a standard, a panorama, a high-vision and a postcard sizes. A slit of the present invention in claim 3 is provided at an upper portion of a film cover to insert particularly a panorama-sized photograph. A high-vision-sized photograph can be inserted from an upper or a bottom slit. Both of a panorama and a high-vision-sized photographs can be pulled out easily from the bottom slit. A slit of the present invention in claim 4 is provided at a slightly upper portion from a center of a film cover to insert particularly a high-vision-sized photograph. A panorama-sized photograph can be inserted from an upper slit, if provided, or a bottom slit when an upper slit is not provided. Both a high-vision and a panorama sized photographs can be pulled out easily from the bottom slit.

### BRIEF DESCRIPTION OF THE DRAWINGS

FIG. 1 is a flat view of a binder insert in the present invention showing one example of embodiments.

FIG. 2 is a front view of a binder insert in the present invention showing another example of embodiments.

FIG. 3 is a front view of a binder insert in the present invention showing further example of embodiments.

FIG. 4 is a front view of a binder insert in a conventional a three-pocket-type album.

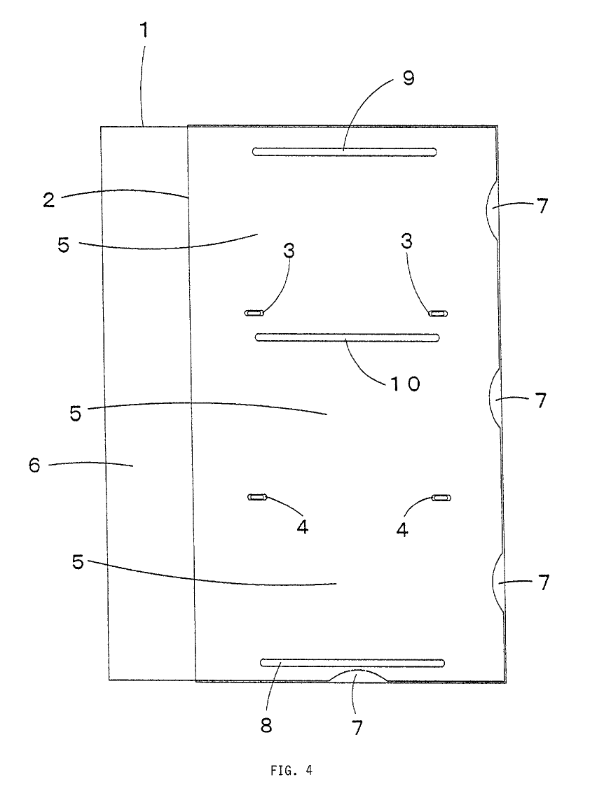

### DETAILED DESCRIPTION OF THE PREFERRED EMBODIMENT

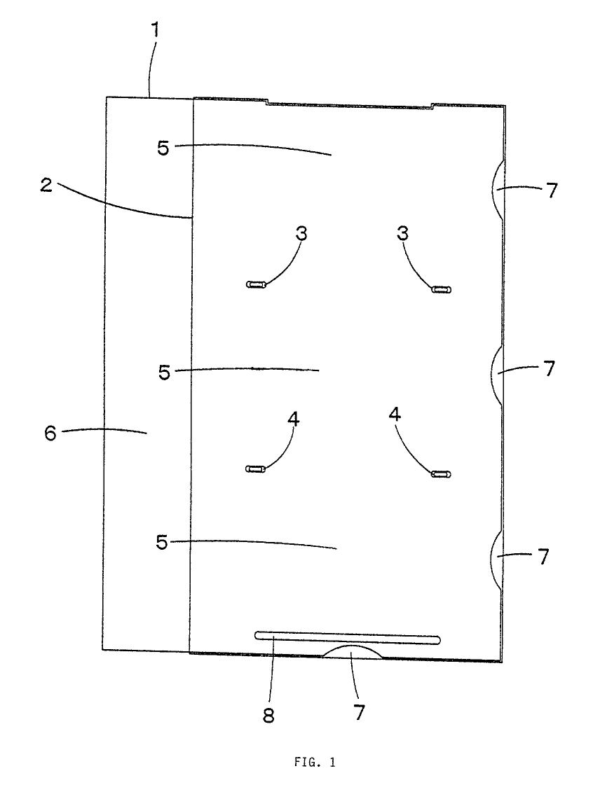

Hereafter, preferred embodiments are discussed referring to the drawings. FIG. 1 is a front view of a binder insert in the present invention. A basic structure thereof is the same as those of a conventional pocket-type album which is comprised of a predetermined size of a mount 1 and a bag-shaped transparent film cover 2 formed by closing bottom and one side. Holes 3 and 4 are punched in the mount 1 at two points where the mount is divided into three equal portions. The film cover 2 is positioned to sheathe front and back covers of the mount 1 and front and back covers thereof are adhered to the mount 1 utilizing the holes 3 and 4 forming three pockets 5. A standard-sized photograph is to be placed in the pocket 5 by inserting thereof from a margin 6 side in the mount 1 where the film cover 2 is opened. In the present embodiment, an upper edge of the film cover 2 is opened for a panorama-sized photograph to be inserted therefrom. However, as this is not an essential requirement, the upper edge may be closed the same as the bottom. In this composition, the margin 6 in the mount 1 is a part for an index and/or comments for a photograph and also a part for holes to be formed for binding. 7 is an arc slit formed in the mount 1. The arc slit 7 is to push out a part of a photograph exposing therefrom to the opposite side when a service-sized photograph placed in the pocket 5 is to be taken out. As the margin 6 in the mount 1 and the slit 7 can be provided voluntary, they are not characteristic points in the present invention. In the FIG. 1, 8 shows a slit to put in and out a panorama and/or a high-vision-sized photograph longer than a service-sized photograph. The slit 8 is formed at an inferior portion in the film cover 2, which is the most important requirement in the present invention.

A binder insert with a structure described above can be used in following ways. A service-sized photograph is stored in the pocket 5 by inserting thereof from the margin 6 in the mount 1, which indicates that the same number of service-sized photographs as the pocket 5 can be stored. Accordingly, maximally 6 service-sized photographs can be stored using both sides of the mount 1 in the case of a service-sized photograph. Conversely, a panorama and/or a high-vision-sized photograph is stored vertically crossing pockets 5. A position of a placed photograph is the same as that of a conventional one. A bottom edge of the photograph is along those of a film cover 2. A photograph placed in the above state can be easily pulled out from a slit 8 with a finger reaching out to a bottom edge thereof as the bottom edge thereof is in the very vicinity of the slit 8.

A binder insert described above is capable to store selectively three kinds of photographs among a standard-service, a panorama and a high-vision sized photographs. In the case of a service-sized photograph, three pieces thereof can be stored in one side. In the case of a high-vision-sized photograph, a piece thereof and a piece of service-sized photograph in the top of a pocket 5 can be stored in one side. In the case of a panorama-sized photograph, only a piece thereof can be stored vertically in one side.

As a postcard-sized photograph, which is one size larger than a service-sized photograph, is provided by APS, a size of each pocket 5 can be modified in order to store a postcard-sized photograph. Even if a size of each pocket 5 corresponds to those of postcard, a service-sized photograph will not be slipped down from the pocket 5 when an interval between holes 4 and 5 is shorter than a longer side of a service-sized photograph. Therefore, a user can chose which kind of photograph between service-sized and postcard size to store.

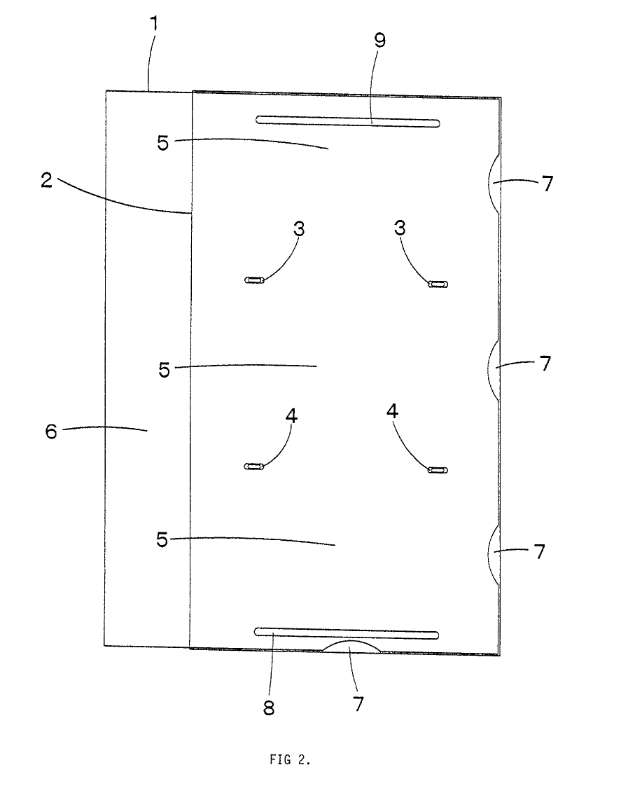

FIG. 2 is a front view of a binder insert in the present invention showing another example of embodiments. A slit 8 provided at an inferior portion of a film cover 2 is the same as one example of embodiments of the present invention. A feature of this embodiment is a slit 9 provided at an upper portion of a film cover 2. The slit 9 is for inserting a panorama and/or a high-vision photograph and the slit 8 is for pulling out thereof.

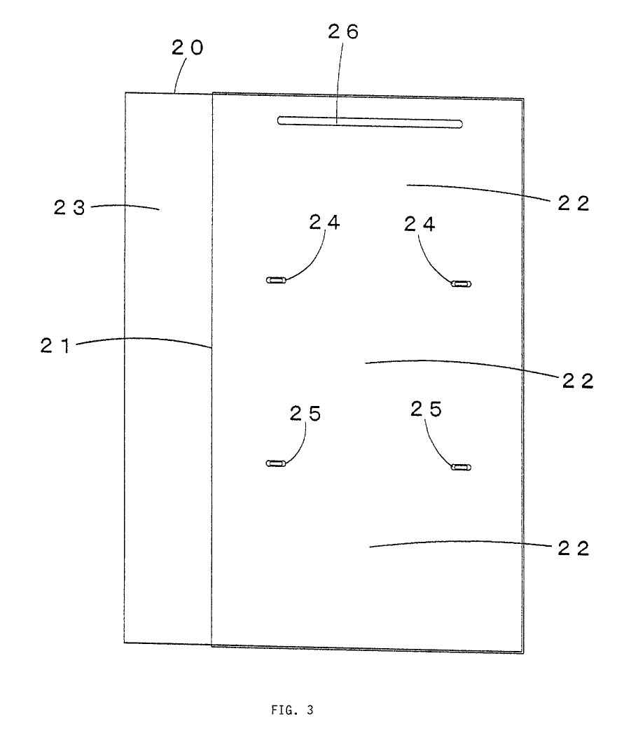

FIG. 3 is a front view of a binder insert in the present invention showing further example of embodiments. A feature of this embodiment is a slit 10 provided at a slightly upper portion from a center of a film cover in addition to a slit 9 provided at an upper portion of the film cover. The slit 10 is especially for inserting a high-vision-sized photograph. Accordingly, the slit 9 is for inserting a panorama-sized photograph and a slit 8 is for pulling out thereof.

Although slits 8, 9 and 10 are set to around 5 mm in the above three embodiments, a small width thereof is better when an appearance is taken into consideration. The best form of a slit is only a slit without a width. However, an important point is that the fingertip can be inserted into a slit and take in and out a panorama and a high-vision-sized photograph from the slit.

As described above, according to the present invention, as a slit is provided at an inferior portion of a film cover to take in and out a panorama and/or a high-vision sized photograph therefrom, the fingertip can easily reach to a photograph longer in width and take out the photograph.

Also, in the description, four kinds of photographs, namely a service-sized, a postcard size, a panorama-sized and a high-vision-sized, has been exemplified in discussing the present invention. However, as the purpose of this invention is freely to lay out a plurality of different size of photographs on one mount, any size of photographs to meet the said purpose may be suitable for the present invention. This point can be comprehended through specification and drawings.

What is claimed:

1. A binder insert comprising of
a mount as a base;
a piece of transparent film cover forming three equal pockets thereon to store at least a service-sized photograph to be inserted from a lateral direction;
a slit provided at an inferior portion of the said film cover for taking out a panorama and/or a high-vision-sized photograph.

2. A binder insert in claim 1, wherein a size of a pocket is adjusted to store a postcard-sized photograph.

3. A binder insert in claim 1 or 2, wherein the said slit is provided at an upper portion of the said film cover to insert a panorama-sized photograph.

4. A binder insert in claim 1, 2 or 3, wherein the said slit is provided at a slightly upper portion from a center of the said film cover to insert a high-vision-sized photograph.
